(19) United States
(12) Patent Application Publication
(10) Pub. No.: US 2026/0358485 A1
(43) Pub. Date: Nov. 12, 2026

(54) Disturbance Detection and Correction in Distance Measurements

(71) Applicant: Silicon Laboratories Inc., Austin, TX (US)

(72) Inventors: Mika Lansirinne, Espoo (FI); Sauli Lehtimaki, Nummela (FI); Markku Majaniemi, Tampere (FI)

(21) Appl. No.: 19/386,856

(22) Filed: Nov. 12, 2025

Related U.S. Application Data
(60) Provisional application No. 63/804,045, filed on May 12, 2025.

(51) Int. Cl. G01S 11/02; H04W 4/80

(52) U.S. Cl. CPC G01S 11/02; H04W 4/80

(57) ABSTRACT

A system and method for determining the distance between two wireless network devices, in the presence of disturbances, is disclosed. The system and method monitors the signal level during one or more Channel Sounding procedures, wherein each Channel Sounding procedure comprises a plurality of measurements. It then compares the average overall signal level of all of the measurements to a subset of the measurements to determine whether there was a disturbance during at least a portion of the distance measurement. If a disturbance was detected, some or all of the measurements are discarded. Any suitable distance measurement algorithm can then be used to determine the distance between the two devices.

This application claims priority to U.S. Provisional Patent Application Ser. No. 63/804,045, filed May 12, 2025, the disclosure of which is incorporated herein by reference in its entirety.

### FIELD

This disclosure describes systems and methods for determining the distance between two wireless network devices, and specifically, detecting disturbances in the Channel Sounding procedure and compensating accordingly.

### BACKGROUND

The Bluetooth protocol has designed several techniques to implement high accuracy distance measurement (HADM). These include a phase based ranging approach and a round trip time approach. Typically, there are two devices associated with these approaches; an initiator device that initiates the distance measurement and a reflector device, which responds to the initiator device. The distance being measured is the distance between these two devices.

In the round trip time (RTT) approach, each device uses timestamps. Specifically, when a packet is transmitted, the transmitting device records a transmit timestamp. When that packet arrives, a receive timestamp is used by the receiving device. In the phase based approach, the initiator device determines the incoming phase for signals transmitted at two different frequencies. The phase measured {θᵢₙᵢₜ) at the initiator device may be approximately the difference in phase between the two devices (i.e. Δθᵢᵣ), added to the product 2π*f*(tp), where f is the frequency of the transmitted signal and tp is the trip delay. If this phase is measured at two different frequencies, and the difference is taken, the result is (θᵢₙᵢₜ₁)−(θᵢₙᵢₜ₂)=2π*f1*(tp)−2π*f2*(tp), or 2*π*(f1−f2)*(tp). Based on this equation, the trip delay may be calculated and then converted to a distance. This approach may be enhanced through the use of spectral analysis algorithms, such as the multiple signal classification (MUSIC) algorithm. The MUSIC algorithm uses this information to generate pseudo-spectrums which may be used to determine the distance between the two devices.

However, these existing algorithms have limitations. For example, if there are other devices in the network that are transmitting when the initiator and target devices are communicating, the signals from these other transmissions may affect the results.

Consequently, a system and method that can determine the presence of disturbances when distance measurements are ongoing would be beneficial. Further, it would be advantageous if the improved system did not require a large amount of computational processing.

### SUMMARY

A system and method for determining the distance between two wireless network devices, in the presence of disturbances, is disclosed. The system and method monitors the signal level during one or more Channel Sounding procedures, wherein each Channel Sounding procedure comprises a plurality of measurements. It then compares the average overall signal level of all of the measurements to a subset of the measurements to determine whether there was a disturbance during at least a portion of the distance measurement. If a disturbance was detected, some or all of the measurements are discarded. Any suitable distance measurement algorithm can then be used to determine the distance between the two devices.

According to one embodiment, a method of calculating a distance between two wireless network devices is disclosed. The method comprises performing one or more Channel Sounding procedures, each Channel Sounding procedure comprising a plurality of measurements; measuring an average overall signal level of all of the plurality of measurements; separating the plurality of measurements into a plurality of groups; discarding at least some of the plurality of measurements if a ratio of an average signal level of measurements in at least one of the plurality of groups to the average overall signal level is greater than a threshold; and if all of the plurality of measurements are not discarded, calculating the distance between the two wireless network devices using remaining measurements; or if all of the plurality of measurements are discarded, performing one or more additional Channel Sounding procedures and repeating the measuring, separating, discarding and calculating. In some embodiments, all of the plurality of measurements are discarded if the ratio of the average signal level of measurements in at least one of the plurality of groups to the average overall signal level is greater than the threshold. In some embodiments, a plurality of Channel Sounding procedures are performed, and each group comprises measurements associated with one Channel Sounding procedure. In some embodiments, each group comprises measurements associated with a particular frequency. In some embodiments, at least one of the two wireless network devices comprises more than one antennas, and each Channel Sounding procedure performs measurements using a plurality of antenna combinations, wherein each group comprises measurements associated with a particular antenna combination. In some embodiments, the average signal level of measurements in each group is compared to the average overall signal level and any groups in which the ratio is greater than the threshold are discarded. In some embodiments, the Channel Sounding procedure comprises transmitting signals between the two wireless network devices, and the signal levels are computed using I and Q signals generated from the signals received by each of the two wireless network devices. In some embodiments, the distance is calculated using a spectral analysis algorithm or a power ratio algorithm.

According to another embodiment, a Bluetooth network device is disclosed. The Bluetooth network device comprises a Bluetooth network interface; a processing unit; and a memory device, wherein the memory device comprises instructions, which when executed by the processing unit, enable the Bluetooth network device to act as an initiator device and to: perform one or more Channel Sounding procedures with a reflector device, each Channel Sounding procedure comprising a plurality of measurements; measure an average overall signal level of all of the plurality of measurements; separate the plurality of measurements into a plurality of groups; discard at least some of the plurality of measurements if a ratio of an average signal level of measurements in at least one of the plurality of groups to the average overall signal level is greater than a threshold; and if all of the plurality of measurements are not discarded, calculate a distance between the initiator device and the reflector device using remaining measurements; or if all of the plurality of measurements are discarded, perform one or more additional Channel Sounding procedures and repeat the measure, separate, discard and calculate. In some embodiments, all of the plurality of measurements are discarded if the ratio of the average signal level of measurements in at least one of the plurality of groups to the average overall signal level is greater than the threshold. In some embodiments, a plurality of Channel Sounding procedures are performed by the initiator device, and each group comprises measurements associated with one Channel Sounding procedure. In some embodiments, each group comprises measurements associated with a particular frequency. In some embodiments, at least one of the initiator device or the reflector device comprises more than one antennas, and each Channel Sounding procedure performs measurements using a plurality of antenna combinations, wherein each group comprises measurements associated with a particular antenna combination. In some embodiments, the average signal level of measurements in each group is compared to the average overall signal level and any groups in which the ratio is greater than the threshold are discarded. In some embodiments, the Bluetooth network interface comprises a low noise amplifier, a mixer and an analog to digital converter to generate I and Q signals from signals received from the reflector device, and wherein the signal levels are computed using the I and Q signals. In some embodiments, the distance is calculated using a spectral analysis algorithm or a power ratio algorithm.

According to another embodiment, a method of calculating a distance between two wireless network devices is disclosed. The method comprises wirelessly collecting a plurality of measurements; measuring an average overall signal level of all of the plurality of measurements; separating the plurality of measurements into a plurality of groups; discarding at least some of the plurality of measurements if a ratio of an average signal level of measurements in at least one of the plurality of groups to the average overall signal level is greater than a threshold; and if all of the plurality of measurements are not discarded, calculating the distance between the two wireless network devices using remaining measurements; or if all of the plurality of measurements are discarded, wirelessly collecting additional measurements and repeating the measuring, separating, discarding and calculating. In some embodiments, each group comprises measurements associated with a particular frequency. In some embodiments, at least one of the two wireless network devices comprises more than one antennas, and each group comprises measurements associated with a particular antenna combination. In some embodiments, the average signal level of measurements in each group is compared to the average overall signal level and any groups in which the ratio is greater than the threshold are discarded. In some embodiments, the distance is calculated using a spectral analysis algorithm or a power ratio algorithm.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a representative initiator device that may estimate distance according to one embodiment;

FIG. 2 shows a network having an initiator device and at least one reflector device according to one embodiment;

FIG. 3 shows a flowchart to determine the distance between two wireless network devices according to one embodiment;

FIG. 4 shows a flow chart used to calculate the distance according to a power ratio algorithm;

FIGS. 5A-5B show the power ratio and cumulative power ratio for a first configuration; and

FIGS. 6A-6B show the power ratio and cumulative power ratio for a second configuration.

### DETAILED DESCRIPTION

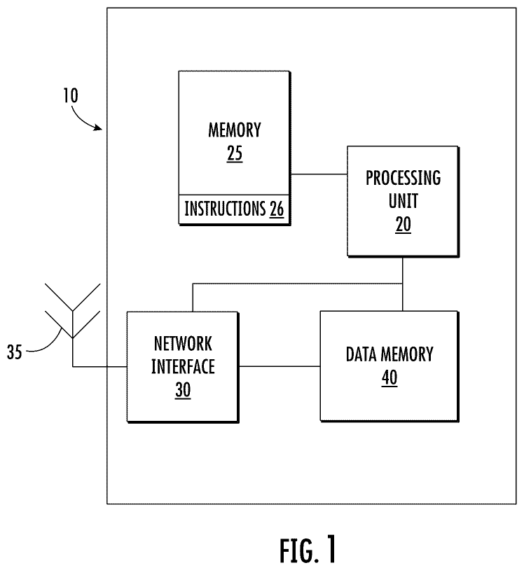

FIG. 1 shows a block diagram of a representative network device. This network device may serve as an initiator device 10, as described in more detail below. This network device may also be used to determine the distance to a remote device, also referred to as a reflector device.

The initiator device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the initiator device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

The initiator device 10 also includes a network interface 30, which may be a wireless interface including an antenna element 35.

The wireless signals first enter the network interface 30 through antenna element 35. The antenna element 35 is in electrical communication with a low noise amplifier (LNA). The LNA receives a very weak signal from the antenna element 35 and amplifies that signal while maintaining the signal-to-noise ratio (SNR) of the incoming signal. The amplified signal is then passed to a mixer. The mixer is also in communication with a local oscillator, which provides two phases to the mixer. The cosine of the frequency may be referred to as Iₒ, while the sin of the frequency may be referred to as Qₒ. The Iₒ signal is then multiplied by the incoming signal to create the inphase signal, Iₘ. The Qₒ signal is then multiplied by a 90° delayed version of the incoming signal to create the quadrature signal, Qₘ. The inphase signal, Iₘ, and the quadrature signal, Qₘ, from the mixer are then fed into programmable gain amplifier (PGA). The PGA amplifies the Iₘ and Qₘ signals by a programmable amount. These amplified signals may be referred to as I_{g} and Q_{g}. The amplified signals, I_{g} and Q_{g}, are then fed from the PGA into an analog to digital converter (ADC). The ADC converts these analog signals to digital signals, I_{d} and Q_{d}. These digital signals may then pass through a channel filter. The filtered signals are referred to as I and Q. These I and Q signals can be used to recreate the amplitude and phase of the original signal. Specifically, the amplitude of the original signal may be represented as \sqrt{I²+Q²}.

The network interface 30 may support any wireless network, such as Bluetooth, Wi-Fi, networks utilizing the IEEE 802.15.4 specification, such as Zigbee, networks utilizing the IEEE 802.15.6 specification, and wireless smart home protocols, such as Z-Wave. The network interface 30 is used to allow the initiator device to communicate with other devices disposed on the network.

The initiator device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other nodes in the network. Although not shown, the initiator device 10 also has a power supply, which may be a battery or a connection to a permanent power source, such as a wall outlet.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions 26 may be written in any programming language and is not limited by this disclosure. Thus, in some embodiments, there may be multiple computer readable media that contain the instructions described herein. The first computer readable media may be in communication with the processing unit 20, as shown in FIG. 1. The second computer readable media may be a CDROM, or a different memory device, which is located remote from the initiator device 10. The instructions contained on this second computer readable media may be downloaded onto the memory device 25 to allow execution of the instructions by the initiator device 10.

While the processing unit 20, the memory device 25, the network interface 30, and the data memory device 40 are shown in FIG. 1 as separate components, it is understood that some or all of these components may be integrated into a single electronic component. Rather, FIG. 1 is used to illustrate the functionality of the initiator device 10, not its physical configuration.

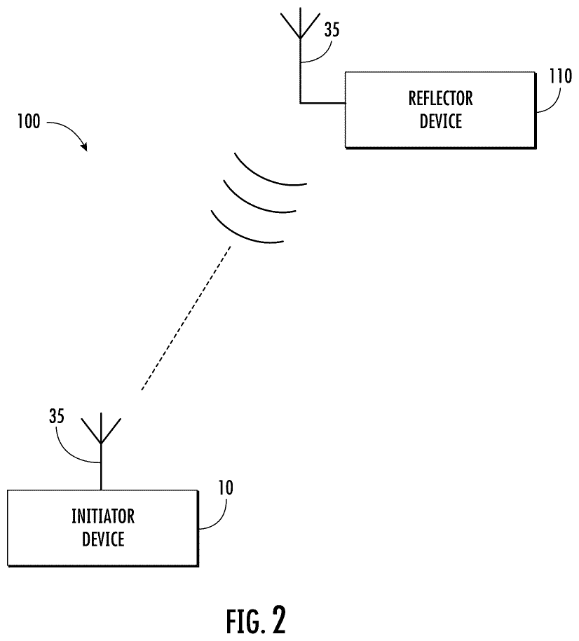

FIG. 2 shows a network 100 having at least one reflector device 110 and an initiator device 10. In certain embodiments, the reflector device 110 may be a network device and contain many of the components described above and shown in FIG. 1. However, the reflector device 110 may have a smaller amount of memory and may have less computational ability.

In FIG. 2, the initiator device 10 may transmit a signal, containing a sine wave having a first frequency to the reflector device 110. In response, the reflector device 110 may transmit a signal containing a sine wave having the same first frequency toward the initiator device 10.

In certain embodiments, this signal is transmitted using a wireless network protocol, such as Bluetooth.

In certain embodiments, at least one of the initiator device 10 and the reflector device 110 may have more than one antennas. In certain embodiments, the sequence described above may be performed using a variety of combinations of transmit and receive antennas.

The initiator device 10 may utilize the I and Q signals described above to determine the amplitude and phase of the signal arriving at the antenna element 35. This information may then be used to calculate the distance from the initiator device 10 to the reflector device 110.

Specifically, the Bluetooth specification describes a Channel Sounding procedure, during which the initiator device 10 transmits a first signal at a first frequency to the reflector device 110. The reflector device 110 measures the signal level and phase of the incoming first signal. In response, the reflector device 110 transmits a second signal having the first frequency back to the initiator device 10. The initiator device 10 measures the signal level and phase of the incoming second signal. This may be repeated for a number of different frequencies. Based on the signal level and phase information gathered by the initiator device 10 and the reflector device 110, the channel transfer function (H) may be estimated. Note that the term “channel transfer function” is synonymous with “channel frequency response”.

As a specific example, the Bluetooth specification defines the following procedure to determine the channel transfer function.

First, θ_{CH}(f) represents the phase delay of the channel, where f is the channel frequency, and Δθ_{LO}(f) represents the relative difference in phase of the RF carrier between the initiator device and the reflector device. Based on this, the relative phases of a carrier measured at the reflector and initiator's antenna is θ_{REFL} (f)=θ_{CH} (f)+Δθ_{LO} (f) and θ_{INIT}(f)=θ_{CH} (f)−Δθ_{LO} (f). Δ_{REFL} (f) and Δ_{INIT}(f) represent the amplitude of that measured carrier at the reflector and initiator's antenna, respectively. Phase correction term (PCT) is defined by the angle that, if added to the internal angle of the local oscillator, would result in a phase identical to that of the incoming signal. The I and Q values represented by the PCT measured at the reflector and initiator, respectively, are given by PCT_{REFL}(f)=A_{REFL}(f)e^{iθ}_{REFL} (f) and PCT_{INIT}(f)=Δ_{INIT} (f) e^{iθ}_{INIT} (f). If the communication channel is symmetrical between the initiator device 10 and the reflector device 110, the measured phases are dependent on both the communication channel and the relative difference in phase of the RF carrier between the devices. The communication channel transfer function can then be estimated from H² (f)=A_{REFL} (f)e^{iθ}_{REFL} (f)×Δ_{INIT} (f) e^{iθ}_{INIT} (f)=A_{CH}_{²}(f) e^{i2θ}_{CH} (f).

The channel transfer function (also referred to as channel frequency response) may then be used to compute the distance between the initiator device 10 and the reflector device 110.

Note that the Bluetooth specification allows up to four antennas per device and also mandates that the Channel Sounding procedure may utilize up to four different antenna combinations based on different antennas used by the initiator device 10 and/or the reflector device 110. Thus, the channel transfer function described above may include data from up to four different antenna combinations.

Furthermore, in some embodiments, the Channel Sounding procedure may be repeated a plurality of times to increase the accuracy of the distance result.

The channel frequency response may then be used to calculate the distance between the initiator device 10 and the reflector device 110.

As noted above, during the Channel Sounding procedure, there may be a disturbance. This disturbance may be a communication between two other devices on the same network or on a different network. Of course, there may be other causes of this disturbance. However, importantly, these disturbances may affect the accuracy of the distance measurement.

Note that the disturbance may also be caused by constructive or destructive interference caused by non-line-of-sight (NLOS) reflections. However, it is important to note that the amount of signal amplitude increase caused by constructive interference is typically limited to roughly two times (i.e. +6 db). Note that the effects of constructive and destructive interference are a function of the signal frequency, and therefore are likely not present through the entire Channel Sounding procedure.

However, other types of disturbance may have a greater effect on the amplitude of the signals exchanged between the initiator device 10 and the reflector device 110. For example, if these disturbances cause the ratio of the signal level during some time period to the average signal level observed during the entire procedure to be greater than some threshold, it may indicate that there is a disturbance during that time period. The threshold used to determine whether there is a disturbance may be determined empirically, or may be calculated theoretically. However, this threshold may be more than 2.

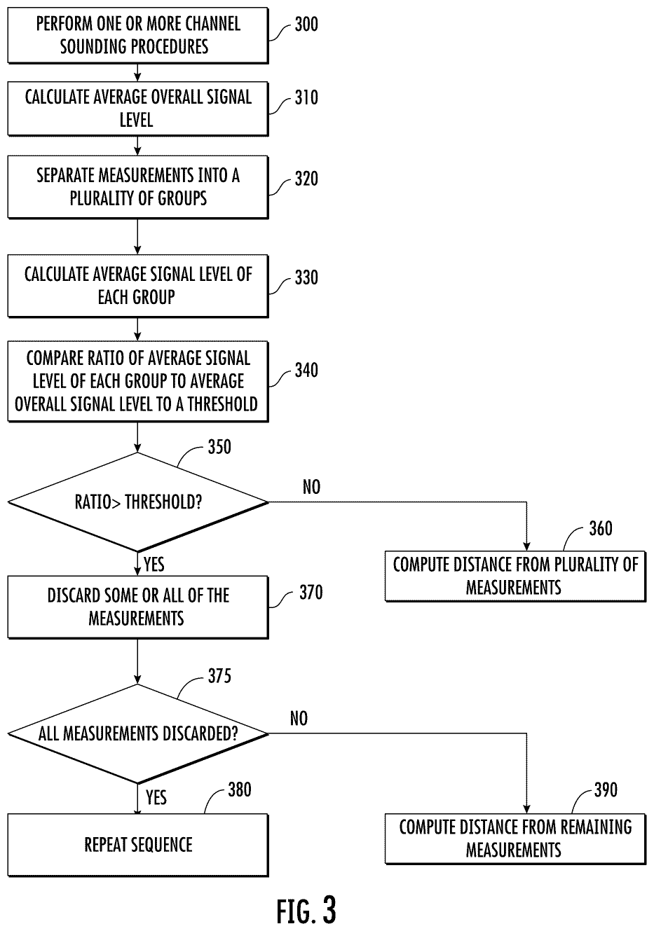

Using this information, it is possible to improve the quality of distance measurements. A flowchart of this sequence is shown in FIG. 3. First, one or more Channel Sounding procedures are performed, as shown in Box 300. As described above, each Channel Sounding procedure comprises a plurality of measurements. These measurements are performed using different frequency channels, and optionally different antenna combinations. After the one or more Channel Sounding procedures are performed, an average overall signal level may be determined, as shown in Box 310. The average overall signal level may be calculated in a plurality of ways. In one embodiment, the sum of the amplitudes of all of the samples, which are each defined as \sqrt{I²+Q²}, is calculated and divided by the number of samples. In another embodiment, to reduce the number of calculations, the average overall signal level may be defined as the sum of the amplitudes, squared, (I²+Q²) of all of the samples, divided by the number of samples. In another embodiment, the I and Q values are treated as a complex number and each signal level is calculated based on that complex number and its conjugate. Note that in all of these embodiments, the I and Q values for each sample are used to determine the average overall signal level. Next, the measurements from the one or more Channel Sounding procedures may be separated into groups, as shown in Box 320. These groups may be based on a common attribute. For example, in the case that multiple Channel Sounding procedures are performed, each group may comprise all of the measurements associated with one Channel Sounding procedure. Alternatively, all measurements performed at a specific frequency channel may be defined as a group. In another embodiment, in the case where multiple antennas are used by the initiator device 10 and/or the reflector device 110, all measurements performed using a particular antenna combination may be defined as a group. The average signal level of each group may be calculated, as shown in Box 330. In one embodiment, the average signal level of each group may then be compared to the average overall signal level to create a ratio, as shown in Box 340. If the ratio of the average signal level of at least one group to the average overall signal level is greater than the predetermined threshold, a disturbance is detected, as shown in Decision Box 350. If there are no ratios that are greater than the predetermined threshold, the distance is calculated using all of the plurality of measurements, as shown in Box 360. If a disturbance is detected, a corrective action is taken. Boxes 370, 380 and 390 together describe the possible corrective actions. This corrective action may comprise discarding some or all of the plurality of measurements, as shown in Box 370. If all of the measurements are discarded, the entire sequence is repeated as shown in Box 380. In another embodiment, the corrective action may comprise discarding only some of the measurements, such as, for example, the measurements from the group with the high ratio. In this embodiment, the distance between the devices may be computed using the remaining measurements, as shown in Box 390. Note that if the corrective action always comprises discarding all of the plurality of measurements, then Box 340 may be modified so that only the group with the highest average signal level is compared to the average overall signal level. If this ratio is greater than the threshold, then all of the measurements are discarded. Conversely, if this ratio is less than the threshold, the flowchart continues to Box 360.

For Box 360, all of the measurements may be provided to any algorithm for spectral analysis, such as Multiple Signal Classification (MUSIC), MATRIX PENCIL, Inverse Fast Fourier Transform (IFFT) or others, as is known to those skilled in the art. In the case of the corrective action shown in Box 390, the remaining measurements may be provided to any of these algorithms.

In other embodiments, a different algorithm, referred to as the Power Ratio algorithm, may be used. The Power Ratio algorithm uses the channel frequency response as its input. In the case of corrective action, some of the measurements may be omitted from the channel frequency response.

To perform the Power Ratio algorithm, an autocorrelation of the channel frequency response (which may include all of the measurements or less than all of the measurements, depending on the results of Decision Box 350) is computed to improve the signal to noise ratio. In one particular implementation, the autocorrelation of the channel frequency response is performed using the following algorithm:

$${\hat{H}}_{k} = {\sum }_{j = K - k + 1}^{K} {H}_{k + j - K} {H}_{j}^{*} , if k \leq K$$

$${\hat{H}}_{k} = {\hat{H}}_{2 K - k}^{*} , if K < k \leq 2 K - 1$$

In these equations,

$${H}_{k}^{*}$$

refers to the complex conjugate of Hₖ. In other words, if Hₖ=a+bi, then

$${H}_{k}^{*} = a - b i .$$

In these equations, K represents the number of frequencies used to generate the channel frequency response (H).

Next, the power of a signal path at a predetermined distance may be estimated by de-rotating the signal path phase from the autocorrelated channel frequency response and assuming that the mean power of all other components will approximate zero.

This can then be used to calculate the power ratio at each distance, x. Specifically, the power ratio may be defined as:

$$φ ( x ) = \frac{{P}_{s} ( x )}{{P}_{H}}$$

where Pₛ(x) is the trial signal power, and P_{H} is the total power of the autocorrelated channel frequency response.

The Power Ratio algorithm creates a spectrum and then determines the line of sight path based on several parameters. Specifically, the Power Ratio algorithm may also integrate the spectrum and use the slope of the resulting integrated spectrum to determine the line of sight path, as explained below.

The trial signal power may be computed by de-rotating the signal path phase with the autocorrelated channel frequency response, as stated above. The signal path phase may be defined using a fixed matrix, where the columns of that matrix represent different distances and the rows represent different frequencies. This matrix represents the signal path phase at various distances and frequencies.

Thus, D(f,d) is the signal path phase at frequency f at distance d. The values of some of the frequencies used to populate this matrix may be selected to be the same as the frequencies present in the channel frequency response. For example, some of these frequencies may coincide with the frequencies of the various Bluetooth channels. The distances may represent the desired granularity of the measurement. For example, the distance may be set to large numbers (such as 1 meter) if the device is known to be far away, but may be set to a smaller number, such as 5 cm if the device is closer.

The signal path phase at each location in the matrix may be defined as:

$$D ( f , d ) = {e}^{\frac{i 2 π fd}{c}}$$

Further, the trial signal power may be computed by first multiplying the signal path phase by the autocorrelated channel frequency response Ĥ to obtain the de-rotated frequency response. Ĥ is defined as a (2K−1)×1 array, wherein K represents the number of frequencies that were used to compute the channel frequency response. Thus, the de-rotated frequency response, represented by V, may be defined as:

V=DεĤ,

Where ⊗ represents a point-wise multiplication of each element in each column of D with the corresponding element in Ĥ. In other words,

V(f,d)=D(f,d)*Ĥ(f)

Based on this de-rotated frequency response and the autocorrelated channel frequency response, the power ratio may be computed as follows:

$$φ ( x ) = \frac{{\vert \frac{1}{2 N - 1} {\sum }_{k} V ( k , x ) \vert}^{2}}{\frac{1}{2 N - 1} {\sum }_{k} ( {\vert \hat{H} ( k ) \vert}^{2} )}$$

In this equation,

$${\vert \frac{1}{2 N - 1} {\sum }_{k} V ( k , x ) \vert}^{2}$$

approximates the trial signal power over all frequencies at distance x, and

$$\frac{1}{2 N - 1} {\sum }_{k} ( {\vert \hat{H} ( k ) \vert}^{2} )$$

represents the total power of the autocorrelated channel frequency response. Thus, the power ratio represents the ratio of the power at distance x to the total power. Thus, the summation of the power ratios for distances should be 1, as this will represent the total power as well.

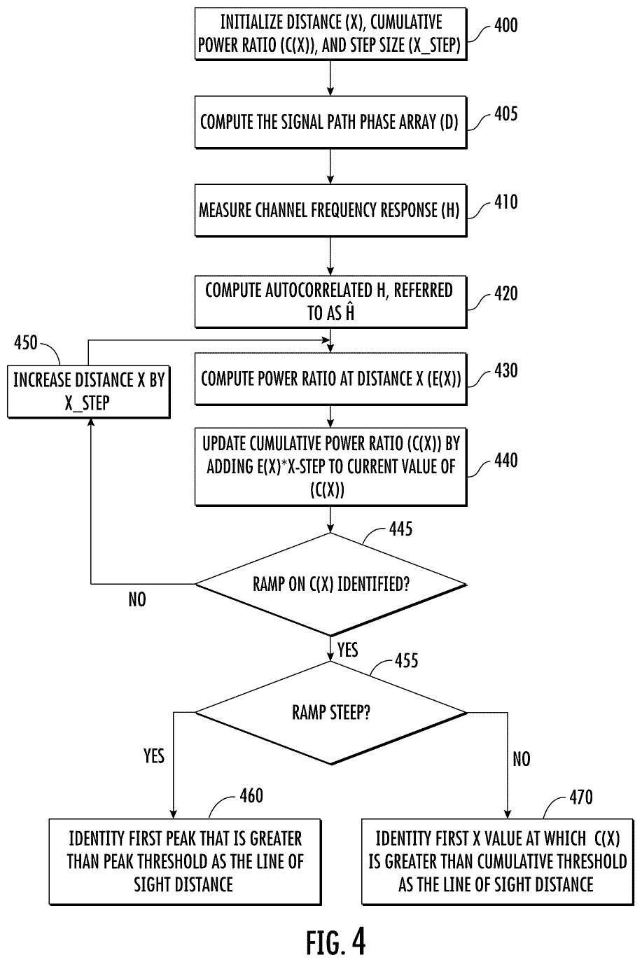

FIG. 4 shows a flow chart that may be used to determine a distance between two devices using this algorithm.

First, as shown in Box 400, several variables are initialized. These include the cumulative power ratio (C(x)), the starting distance (x) and the distance step size (x_step).

Next, as shown in Box 405, the signal path phase at each of the frequencies is calculated and stored in the array D(f,d). Specifically, for each frequency, the signal path phase for each frequency is generated using the equation for D shown above.

As shown in Box 410, the Channel Sounding Procedure is performed and the channel frequency response (H) is calculated based on this procedure.

Next, as shown in Box 420, the autocorrelation of the channel frequency response H, referred as to Ĥ, is computed using the equations described above.

As shown in Box 430, the power ratio at the distance value, x, is then computed. To do this, the phase values of the array D(f,d) (one for each frequency) are multiplied by the autocorrelated channel frequency response at that frequency to create the de-rotated frequency response for the trial signal at each frequency.

Once this has been performed for each frequency, the power of the trial signal can be calculated as the square of the mean value of the de-rotated frequency response for the trial signal across all frequencies. The power ratio can then be calculated using the expression shown below:

$$φ ( x ) = \frac{{\vert \frac{1}{2 N - 1} {\sum }_{k} V ( k , x ) \vert}^{2}}{\frac{1}{2 N - 1} {\sum }_{k} ( {\vert \hat{H} ( k ) \vert}^{2} )}$$

Once the power ratio at a specific distance is determined, this value is then multiplied by the x_step value and added to the cumulative power ratio, as shown in Box 440.

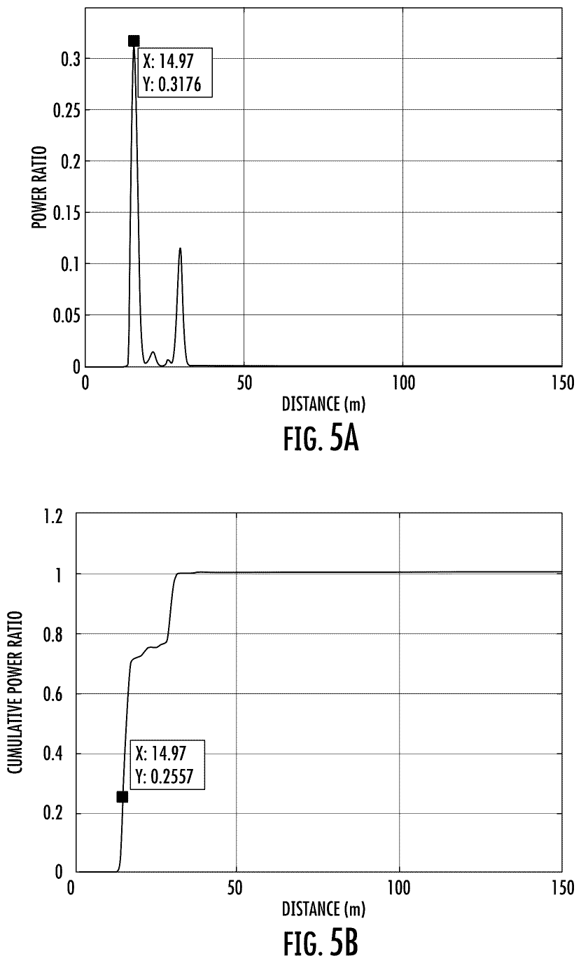

This process may then repeat until enough values have been computed to identify the ramp in the cumulative power ratio, as shown in Decision Box 445 and Box 450. The result of these operations are a power ratio curve and a cumulative power ratio curve. Example curves are shown in FIGS. 5A-5B. FIG. 5A shows the power ratio computed for each distance. FIG. 5B is the cumulative power ratio for each distance. Note that the cumulative power ratio is an estimation of the integral of the power ratio curve in FIG. 5A.

A ramp is defined as an upward trend in the cumulative power ratio curve. In certain embodiments, the end of the ramp is defined as the distance, referred to as x_endramp, at which the cumulative power ratio exceeds a predetermined high ramp threshold. This predetermined high ramp threshold may be a fixed value, such as a value between 0.2 and 0.8, and more particularly between 0.3 and 0.5. Alternatively, it may be dynamically varied. To properly define the slope of the ramp, a start of the ramp is also required. In certain embodiments, the start of the ramp, is defined as the distance, referred to as x_startramp, at which the cumulative power ratio exceeds a predetermined low ramp threshold. In certain embodiments, the low ramp threshold may be a fixed value, such as a value between 0.001 and 0.1. The difference between the end distance and the start distance, defined as x_endramp−x_startramp, may be used to determine the steepness of the slope, as shown in Decision Box 455. Specifically, small values of this difference indicate a steep slope, while larger values of this difference indicate a less steep, or more gradual slope. In one embodiment, the difference between the end distance and the start distance is compared against a fixed slope threshold. Differences below this fixed steepness threshold are classified as a steep ramp; differences greater than this fixed steepness threshold are classified as not being a steep ramp. In certain embodiments, the fixed steepness threshold may be between 3 meters and 5 meters, although other values may be used. In some embodiments, the steepness threshold may be related to the values chosen for the low ramp threshold and high ramp threshold. A broader range of threshold ranges may result in a high steepness threshold.

The line of sight distance may be computed differently, depending on the steepness of the ramp. As shown in Box 460, if the ramp is steep, the line of sight distance is defined to be the first peak in the power ratio curve that exceeds a predetermined peak threshold. This may be referred to as a type 1 scenario.

In one embodiment, a peak is identified by starting from 0 meters and looking for a power ratio that is smaller than the previous power ratio. If this power ratio is smaller than the previous one, then the previous distance is saved as the peak. Otherwise, the current power ratio is saved as the previous power ratio and the distance is incremented. This process repeats until the peak is found. This peak is then compared to a predetermined peak threshold. If it is greater than that peak threshold, this peak is referred to as the first peak. Thus, the first peak may be defined as the smallest distance that indicated a power ratio greater than a predetermined peak threshold. This peak threshold could be determined empirically or may be a predetermined value. In some embodiments, the peak threshold may be set to a value of 0.1 or greater. If the peak is not greater than the predetermined peak threshold, the process repeats until a first peak is found.

This methodology is seen in FIGS. 5A-5B. Note that the ramp in FIG. 5B is very steep. Thus, in this scenario, the first peak in the power ratio curve, which was found to be at 14.97 meters, is used as the line of sight distance.

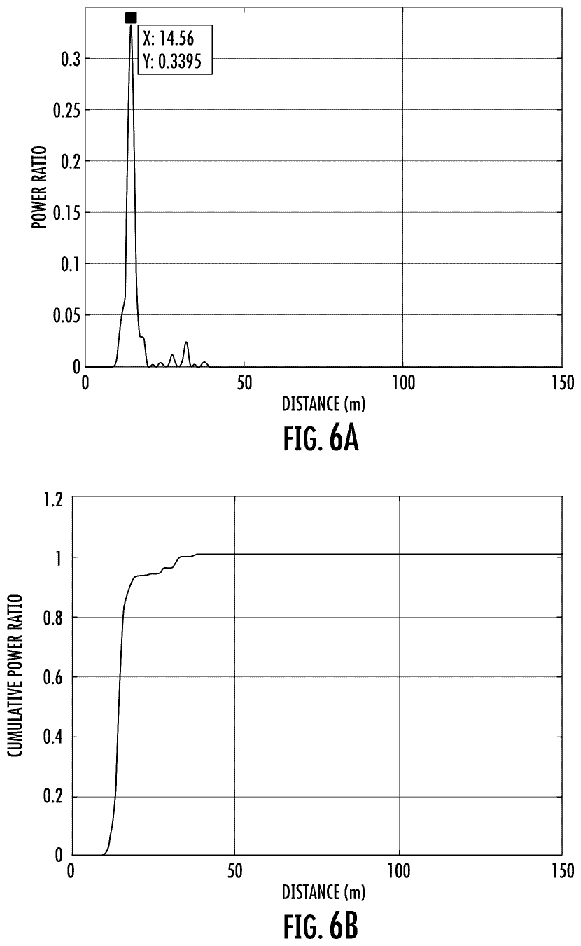

If the ramp is not determined to be steep, a different computation is used to determine the line of sight distance, as shown in Box 470. This may be referred to as a type 2 scenario. For example, FIGS. 6A-6B show the power ratio curve and cumulative power ratio curve for a different environment, respectively. Note that in FIG. 6A, the first peak is wider than that in FIG. 5A, and has a small hump on the left side. This is likely indicative of interference between the actual line of sight distance and a reflection. Consequently, the actual peak associated with the line of sight is likely shifted to the right. Therefore, the technique of simply using the first peak as the line of sight distance may be inaccurate in this situation and may yield a resulting distance that is larger than the actual line of sight distance. Thus, in this situation, the line of sight distance is defined as the distance at which the cumulative power ratio exceeds a cumulative threshold. The value of this cumulative threshold may be selected to be where a significant power increase begins. In some embodiments, the cumulative threshold may be a fixed value, such as between 0.001 and 0.1, although other values may be used. In other embodiments, the cumulative threshold may be dynamically set. For example, the cumulative threshold may be varied in accordance with the steepness of the ramp. For steeper ramps, a larger value of the cumulative threshold may be used, while a smaller value may be used for more gradual slopes.

Note that one advantage of this approach is that the entire spectrum does not need to be computed to determine the actual distance. Rather, the only calculations performed are those that are at distances that are needed to identify and classify the ramp in the cumulative power ratio curve.

Further, it is noted that the flow chart in FIG. 4 is only one approach to determine the line of sight distance. For example, a different peak detection algorithm may be used. In another embodiment, the peak may be detected by monitoring the gradient and looking for a change in the polarity of the gradient. Additionally, rather than looping over distances, some statistical or Monte Carlo method may be used to select the distances that are to be checked. Of course, other computational optimization techniques, which are well known, may also be used. Additionally, in some embodiments, the autocorrelation may be omitted, such as Box 420 is not executed. In this embodiment, the power ratio, cumulative power ratio and other metrics are calculated using the channel frequency response, rather than the autocorrelated channel frequency response.

Further, in other embodiments, the algorithm may assume that all measurements are Type 1 scenarios and always use the first peak as the distance. In some embodiments, an autocorrelation of the channel frequency response may not be performed.

Note that any of the disclosed distance computations may be performed by the initiator device 10. The initiator device 10 may contain the requisite computation power and memory space to perform these calculations. Alternatively, the initiator device 10 may off-load the calculations to a computational device (not shown).

While this disclosure describes the use of a Channel Sounding procedure to obtain the measurements needed to calculate distance, the filtering algorithm described herein may be used with any phase based approach to distance measuring. In these other embodiments, signals are exchanged wirelessly between two devices which allow the collecting of a plurality of measurements. These measurements may be phase-based distance measurements. This plurality of measurements may then be separated into different groups, as described above. These groups may represent different frequencies, different antenna combinations, or another categorization. The remainder of the filtering algorithm may proceed as described above.

The present system has many advantages. In one test, 28 pairs of devices were located in an environment and a spectral analysis algorithm was used to calculate the difference between each pair of devices. In this test, 90% of the calculated distances were within 2.92 meters of the actual distance, and 95% of the calculated distances were within 4.91 meters of the actual distance. The filtering algorithm described above was then utilized to potentially discard disturbances. The test was repeated and 90% of the calculated distances were within 1.81 meters of the actual distance, and 95% of the calculated distances were within 2.47 meters of the actual distance. Thus, when this spectral analysis algorithm is used, there is roughly a reduction of 50% in the 95% distance error.

In another test, the 28 pairs of devices were located in the environment and a second algorithm, which may be the Power Ratio algorithm described above or a variation thereof, was used to calculate the difference between each pair of devices. In this test, the improvement was even more significant, such that there was roughly a 10× reduction in the 95% distance error.

Thus, this filtering technique achieves more accurate results, with limited computational requirements. Further, in environments without noise, this filtering technique has no effect on the distance calculations.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of calculating a distance between two wireless network devices, comprising:
performing one or more Channel Sounding procedures, each Channel Sounding procedure comprising a plurality of measurements;
measuring an average overall signal level of all of the plurality of measurements;
separating the plurality of measurements into a plurality of groups;
discarding at least some of the plurality of measurements if a ratio of an average signal level of measurements in at least one of the plurality of groups to the average overall signal level is greater than a threshold; and
if all of the plurality of measurements are not discarded, calculating the distance between the two wireless network devices using remaining measurements; or
if all of the plurality of measurements are discarded, performing one or more additional Channel Sounding procedures and repeating the measuring, separating, discarding and calculating.

2. The method of claim 1, wherein all of the plurality of measurements are discarded if the ratio of the average signal level of measurements in at least one of the plurality of groups to the average overall signal level is greater than the threshold.

3. The method of claim 1, wherein a plurality of Channel Sounding procedures are performed, and each group comprises measurements associated with one Channel Sounding procedure.

4. The method of claim 1, wherein each group comprises measurements associated with a particular frequency.

5. The method of claim 1, wherein at least one of the two wireless network devices comprises more than one antennas, and each Channel Sounding procedure performs measurements using a plurality of antenna combinations, wherein each group comprises measurements associated with a particular antenna combination.

6. The method of claim 1, wherein the Channel Sounding procedure comprises transmitting signals between the two wireless network devices, and wherein the signal levels are computed using I and Q signals generated from the signals received by each of the two wireless network devices.

7. The method of claim 1, wherein the distance is calculated using a spectral analysis algorithm or a power ratio algorithm.

8. A Bluetooth network device, comprising:
a Bluetooth network interface;
a processing unit; and
a memory device, wherein the memory device comprises instructions, which when executed by the processing unit, enable the Bluetooth network device to act as an initiator device and to:
perform one or more Channel Sounding procedures with a reflector device, each Channel Sounding procedure comprising a plurality of measurements;
measure an average overall signal level of all of the plurality of measurements;
separate the plurality of measurements into a plurality of groups;
discard at least some of the plurality of measurements if a ratio of an average signal level of measurements in at least one of the plurality of groups to the average overall signal level is greater than a threshold; and
if all of the plurality of measurements are not discarded, calculate a distance between the initiator device and the reflector device using remaining measurements; or
if all of the plurality of measurements are discarded, perform one or more additional Channel Sounding procedures and repeat the measure, separate, discard and calculate.

9. The Bluetooth network device of claim 8, wherein all of the plurality of measurements are discarded if the ratio of the average signal level of measurements in at least one of the plurality of groups to the average overall signal level is greater than the threshold.

10. The Bluetooth network device of claim 8, wherein a plurality of Channel Sounding procedures are performed by the initiator device, and each group comprises measurements associated with one Channel Sounding procedure.

11. The Bluetooth network device of claim 8, wherein each group comprises measurements associated with a particular frequency.

12. The Bluetooth network device of claim 8, wherein at least one of the initiator device or the reflector device comprises more than one antennas, and each Channel Sounding procedure performs measurements using a plurality of antenna combinations, wherein each group comprises measurements associated with a particular antenna combination.

13. The Bluetooth network device of claim 8, wherein the Bluetooth network interface comprises a low noise amplifier, a mixer and an analog to digital converter to generate I and Q signals from signals received from the reflector device, and wherein the signal levels are computed using the I and Q signals.

14. The Bluetooth network device of claim 8, wherein the distance is calculated using a spectral analysis algorithm or a power ratio algorithm.

15. A method of calculating a distance between two wireless network devices, comprising:
wirelessly collecting a plurality of measurements;
measuring an average overall signal level of all of the plurality of measurements;
separating the plurality of measurements into a plurality of groups;
discarding at least some of the plurality of measurements if a ratio of an average signal level of measurements in at least one of the plurality of groups to the average overall signal level is greater than a threshold; and
if all of the plurality of measurements are not discarded, calculating the distance between the two wireless network devices using remaining measurements; or
if all of the plurality of measurements are discarded, wirelessly collecting additional measurements and repeating the measuring, separating, discarding and calculating.

16. The method of claim 15, wherein each measurement is a phase-based distance measurement.

17. The method of claim 15, wherein the collecting of the plurality of measurements is referred to as a procedure; and wherein a plurality of procedures are performed, and each group comprises measurements associated with one procedure.

18. The method of claim 15, wherein each group comprises measurements associated with a particular frequency.

19. The method of claim 15, wherein at least one of the two wireless network devices comprises more than one antennas, and wherein each group comprises measurements associated with a particular antenna combination.

20. The method of claim 15, wherein the distance is calculated using a spectral analysis algorithm or a power ratio algorithm.
